(19) United States
(12) Patent Application Publication
(10) Pub. No.: US 2024/0424872 A1
(43) Pub. Date: Dec. 26, 2024

(54) REUSABLE WINDOW SHADE ASSEMBLY

(71) Applicant: Reginald Mc' Neil, Jamaica, NY (US)

(72) Inventor: Reginald Mc' Neil, Jamaica, NY (US)

(21) Appl. No.: 18/212,332

(22) Filed: Jun. 21, 2023

(51) Int. Cl. B60J 3/02

(52) U.S. Cl. CPC B60J 3/0286

(57) ABSTRACT

A reusable window shade assembly includes a sheet of window treatment that has a tint homogenously integrated into the sheet of window treatment. In this way the sheet of window treatment can reduce the intensity of light passing through the sheet of window treatment. The sheet of window treatment is comprised of a deformable material thereby facilitating the sheet of window treatment to be cut into pieces of a pre-determined shape. In this way a respective window to be tinted with a piece of the sheet of window treatment. The sheet of window treatment has adhesive properties to removably adhere to the respective window without the use of any additional adhesive or a preparation solution.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to window shade devices and more particularly pertains to a new window shade device for tinting a window without the use of adhesives or preparation solutions. The device includes a sheet of window treatment that is tinted and which has adhesive properties. The sheet of window treatment can be cut into pieces to fit onto any window and subsequently be adhered to the window to tint the window.

### (2) Description of Related Art Including Information Disclosed Under 37 CFR 1.97 and 1.98

The prior art relates to window shade devices including a variety of window tinting sheets that come in pre-determined sizes and which can be adhered to a window for tinting a portion of the window and a variety of sunshade devices that are attachable to windshield of a vehicle. In no instance does the prior art disclose a self-adhering window tinting sheet that has dimensions large enough to completely cover a window.

### BRIEF SUMMARY OF THE INVENTION

An embodiment of the disclosure meets the needs presented above by generally comprising a sheet of window treatment that has a tint homogenously integrated into the sheet of window treatment. In this way the sheet of window treatment can reduce the intensity of light passing through the sheet of window treatment. The sheet of window treatment is comprised of a deformable material thereby facilitating the sheet of window treatment to be cut into pieces of a pre-determined shape. In this way a respective window to be tinted with a piece of the sheet of window treatment. The sheet of window treatment has adhesive properties to removably adhere to the respective window without the use of any additional adhesive or a preparation solution.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a reusable window shade assembly according to an embodiment of the disclosure.

FIG. 2 is a bottom view of an embodiment of the disclosure.

FIG. 3 is an exploded perspective view of an embodiment of the disclosure.

FIG. 4 is a perspective in-use view of an embodiment of the disclosure showing a window in a building being tinted.

FIG. 5 is a perspective in-use view of an embodiment of the disclosure showing windows of a vehicle being tinted.

### DETAILED DESCRIPTION OF THE INVENTION

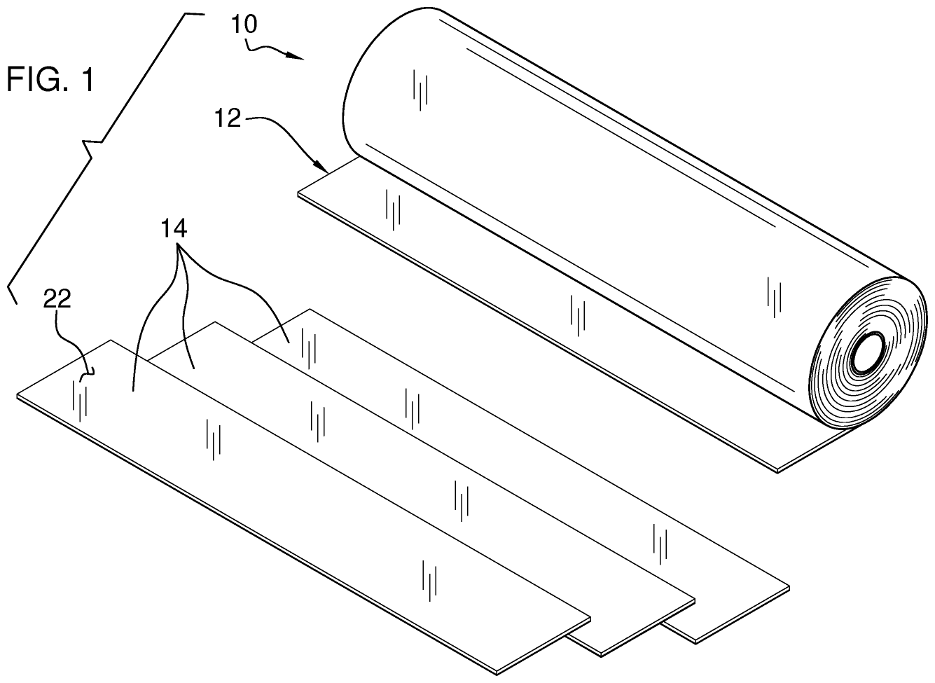

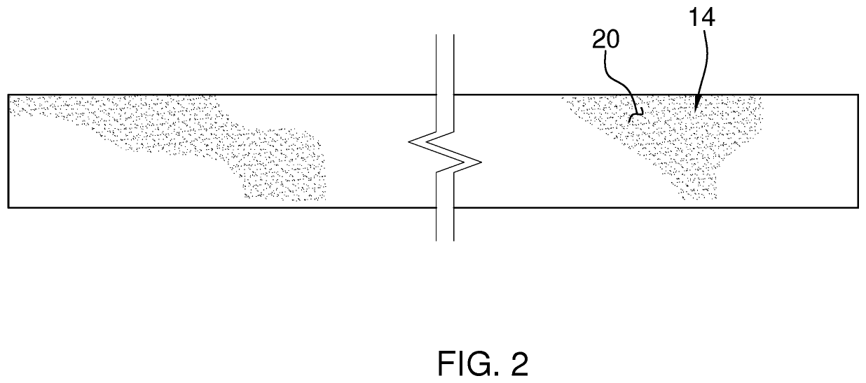

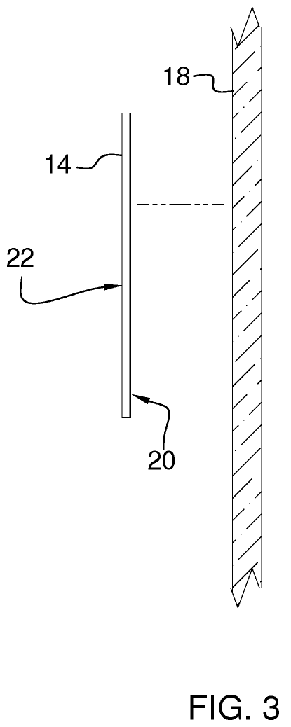

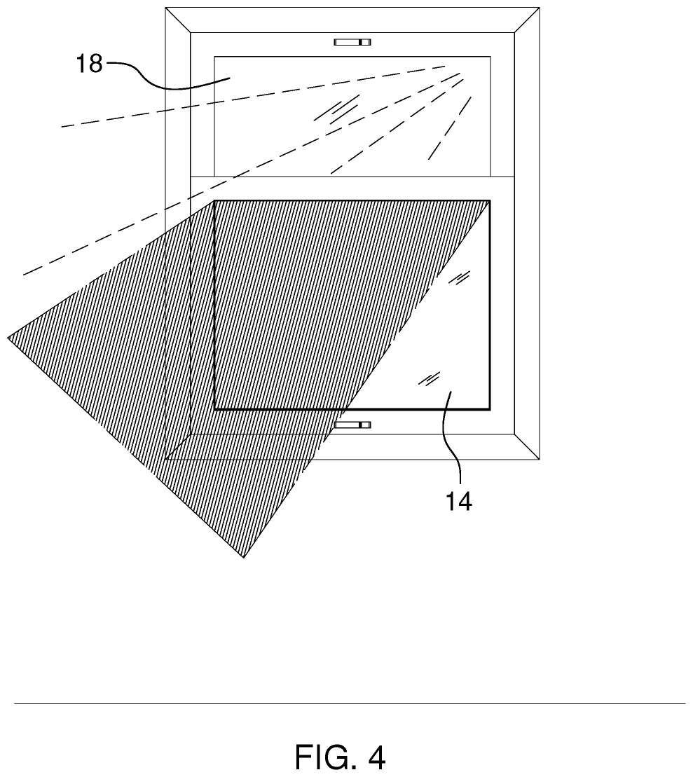

With reference now to the drawings, and in particular to FIGS. 1 through 5 thereof, a new window shade device embodying the principles and concepts of an embodiment of the disclosure and generally designated by the reference numeral 10 will be described.

As best illustrated in FIGS. 1 through 5, the reusable window shade assembly 10 generally comprises a sheet of window treatment 12 that is comprised of a translucent material to pass light through the sheet of window treatment 12. The sheet of window treatment 12 has a tint that is homogenously integrated into the sheet of window treatment 12. In this way the sheet of window treatment 12 can reduce the intensity of light passing through the sheet of window treatment 12. Furthermore, the sheet of window treatment 12 is comprised of a deformable material thereby facilitating the sheet of window treatment 12 to be cut into pieces 14 of a pre-determined shape. In this way the pieces 14 of pre-determined shape can be applied to respective windows 18 thereby facilitating the respective windows 18 to be tinted. The windows 18 may be a window in a house, a window in a vehicle or any other type of window made of glass. Furthermore, the sheet of window treatment 12 may be manufactured in widths of up to 2.0 meters and a length of up to 30.0 meters to facilitate the pieces to be large enough to cover nearly any window 18.

The sheet of window treatment 12 has adhesive properties such that each of the plurality of pieces 14 can removably adhere to the respective window 18 without the use of any additional adhesive or a preparation solution. In this way the windows 18 can be tinted by a person of average skill without the use of adhesives or preparation solutions. The sheet of window treatment 12 has an engaging surface 20 and an exposed surface 22. The engaging surface 20 is comprised of a negatively charged material thereby facilitating the engaging surface 20 to form a weak electrostatic bond with glass. In this way the engaging surface 20 can removably adhere to the respective window 18. The exposed surface 22 is comprised of a cohesive material to inhibit adhering to a surface such that the exposed surface 22 does not attract dust or debris.

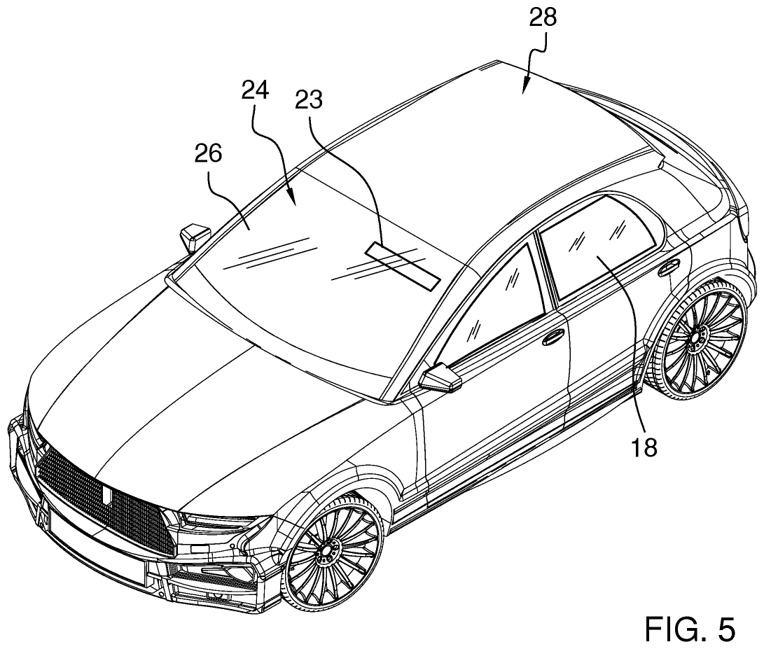

In use, the respective window 18 is measured and a piece of the sheet of window treatment 12 is cut to match the dimensions of the respective window 18. The engaging surface 20 of the piece of the sheet of window treatment 12 is positioned against the glass of the respective window 18 to facilitate the engaging surface 20 to bond to the glass. In this way the respective window 18 can be tinted without the use of adhesives or preparation solutions. Furthermore, the sheet of window treatment 12 can be cut into strips 23, and as is most clearly shown in FIG. 5, one or more of the strips 23 to be applied to an upper threshold 24 of a windshield 26 of a vehicle 28, for example. In this way the sheet of window treatment 12 can be employed to accomplish a variety of different window tinting needs to either partially or fully tint a respective window 18 of any shape or size. Additionally, the piece of the sheet of window treatment 12 can be removed from the respective window 18 to be re-used when the respective window 18 is damaged.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reusable window shade assembly for facilitating windows in a vehicle to be either fully or partially tinted, said assembly comprising:
a sheet of window treatment being comprised of a translucent material wherein said sheet of window treatment is configured to pass light through said sheet of window treatment, said sheet of window treatment having a tint being homogenously integrated into said sheet of window treatment wherein said sheet of window treatment is configured to reduce the intensity of light passing through said sheet of window treatment, said sheet of window treatment being comprised of a deformable material thereby facilitating said sheet of window treatment to be cut into pieces of a pre-determined shape wherein said pieces of pre-determined shape are configured to be applied to a respective window thereby facilitating the respective window to be tinted, said sheet of window treatment having adhesive properties wherein each of said plurality of pieces is configured to removably adhere to the respective window without the use of any additional adhesive or a preparation solution.

2. The assembly according to claim 1, wherein said sheet of window treatment has an engaging surface, said engaging surface being comprised of a negatively charged material.

3. The assembly according to claim 2, wherein said engaging surface forms a weak electrostatic bond with glass wherein said engaging surface is configured to removably adhere to the windows of the vehicle.

4. The assembly according to claim 1, wherein said sheet of window treatment has an exposed surface, said exposed surface being comprised of a cohesive material wherein said exposed surface is configured to inhibit adhering to a surface.

5. A reusable window shade assembly for facilitating windows in a vehicle to be either fully or partially tinted, said assembly comprising:
a sheet of window treatment being comprised of a translucent material wherein said sheet of window treatment is configured to pass light through said sheet of window treatment, said sheet of window treatment having a tint being homogenously integrated into said sheet of window treatment wherein said sheet of window treatment is configured to reduce the intensity of light passing through said sheet of window treatment, said sheet of window treatment being comprised of a deformable material thereby facilitating said sheet of window treatment to be cut into pieces of a pre-determined shape wherein said pieces of pre-determined shape are configured to be applied to respective windows thereby facilitating the respective windows to be tinted, said sheet of window treatment having adhesive properties wherein each of said plurality of pieces is configured to removably adhere to the respective window without the use of any additional adhesive or a preparation solution, said sheet of window treatment having an engaging surface and an exposed surface, said engaging surface being comprised of a negatively charged material thereby facilitating said engaging surface to form a weak electrostatic bond with glass wherein said engaging surface is configured to removably adhere to the windows of the vehicle, said exposed surface being comprised of a cohesive material wherein said exposed surface is configured to inhibit adhering to a surface.

6. A method of tinting a window without the use of adhesives or a preparation solution, the steps of the method comprising:
measuring dimensions of a window to be tinted;
cutting a piece of a sheet of window treatment according to said dimensions of said window to be tinted, said sheet of window treatment having an engaging surface being comprised of a negatively charged material thereby facilitating said engaging surface to form a weak electrostatic bond with glass; and
positioning said piece of said sheet of window treatment onto said window to be tinted, said sheet of window treatment having a tint being homogenously integrated into said sheet of window treatment thereby facilitating said piece of said sheet of window treatment to reduce the intensity of light passing through said window to be treatment.
